(19) United States
(12) Patent Application Publication
(10) Pub. No.: US 2003/0033104 A1
(43) Pub. Date: Feb. 13, 2003

(54) Marking out method and system

(76) Inventor: Richard Michael Gooche, Surrey (GB)

Correspondence Address: Crowell & Moring, Intellectual Property Group, PO Box 14300, Washington, DC, 20044-4300, US

(21) Appl. No.: 10/070,901

(22) PCT Filed: Aug. 30, 2001
(86) PCT No.: PCT/GB01/03865

(30) Foreign Application Priority Data
Sep. 13, 2000 (GB) 0022443.6

(51) Int. Cl. G01C 17/38

(52) U.S. Cl. 702/95

(57) ABSTRACT

A marking out system for use in computer aided manufacture, the system comprising a measurement system (8, 4, 6) and a marking out device (2), the measurement system storing CAD data of a part (12) to be marked out comprising at least one marking out location, the measurement system comprising sensor means (4) and a processing means (6) and being arranged to determine the position and orientation of the part with respect to the measurement system and to establish a co-ordinate frame of reference allowing the position and orientation of the part to be related to the stored CAD data, the measurement system being further arranged to determine the position and orientation of the marking out device relative to the part to enable the marking out device to be positioned in a predetermined position relative to the part such as to allow the part to be marked in a location corresponding to the at least one marking out location.

The present invention relates to a method for marking out assembly or manufacturing schemes on a part or article which is to be machined or assembled in a manufacturing or assembly process, particularly but not exclusively in the aerospace industry.

In manufacturing and assembly operations, knowledge of the exact position and orientation of a part or assembly is often required in order that a manufacturing or assembly operation may be carried out on that part or assembly.

Conventionally, jigs or templates may be made to enable marking out on a localised area of a particular part, picking up on datum points of the part and allowing assembly or machining locations to be located. However, where a high degree of accuracy is required, it may not be possible to accurately locate a jig or a template on the part. In such cases, corresponding inaccuracies will result in the locations of the assembly or machining locations. Furthermore, the cost of designing and manufacturing jigs or templates is not inconsiderable.

An alternative approach to marking out, where it is not possible to accurately locate a jig or a template or to perform the required measurements on the surface of the part which is to be marked out, relies upon the use of drilled pilot holes. Pilot holes may be drilled from one side of the part from which the desired location may be readily established, through to the side of the part which is to be marked out.

Such a technique is used, for example, in the aerospace industry when assembling a wing skin with a wing box, where it is essential to determine accurately from the wing skin side of the structure where to drill attachment holes through the wing skin and into the supporting feet of a rib of the wing box.

This process is conventionally achieved in several separate operations. Firstly, guide holes of a smaller than final diameter may be drilled in the rib feet in the desired locations, prior to offering up the wing skin. Secondly, with the wing skin in place, pilot holes are drilled from inside the wing box outwards through the wing skin, in a process known as “back drilling”. Thirdly, using the pilot holes, the position of the pre-drilled guide holes in the rib feet are estimated. Finally, drilling of assembly holes from the outside of the wing skin through the wing skin and into the supporting rib feet may be commenced.

However, such a process suffers from the disadvantage of introducing further steps in the manufacturing or assembly process. Furthermore, in the event that pilot holes are erroneously drilled in incorrect locations, there is a possibility that the intrinsic strength of the part may be weakened by the corrective work carried out to rectify the inaccurate drilling of the pilot holes.

Therefore, there is a need for a system and method of marking out assembly or manufacturing schemes which overcomes one or more of the disadvantages of the prior art.

According to a first aspect of the present invention, there is provided a marking out system for use in computer aided manufacture, the system comprising a measurement system and a marking out device, the measurement system storing CAD data of a part to be marked out comprising at least one marking out location, the measurement system comprising sensor means and a processing means and being arranged to determine the position and orientation of the part with respect to the measurement system and to establish a co-ordinate frame of reference allowing the position and orientation of the part to be related to the stored CAD data, the measurement system being further arranged to determine the position and orientation of the marking out device relative to the part to enable the marking out device to be positioned in a predetermined position relative to the part such as to allow the part to be marked in a location corresponding to the at least one marking out location.

Advantageously, the system and method of the present invention may be used for marking out a vast range of parts and components, unlike with the use of jigs and templates which are designed and used with specific parts or assemblies.

Preferably, the marking out device is a bubble jet printer head, which may be controlled by the processor. Thus, the speed of operation of the marking out process of the present invention may be greatly increased over the methods of the prior art.

The present invention also extends to the corresponding marking out method and products manufactured by the process of the present invention. Furthermore, the present invention also extends to a computer program and a computer program product, which are arranged to implement the system of the present invention as well as to measurements and CAD models produced using the method of the invention.

Other aspects and embodiments of the invention, with corresponding objects and advantages, will be apparent from the following description and claims. Specific embodiments of the present invention will now be described by way of example only, with reference to the accompanying drawings, in which:

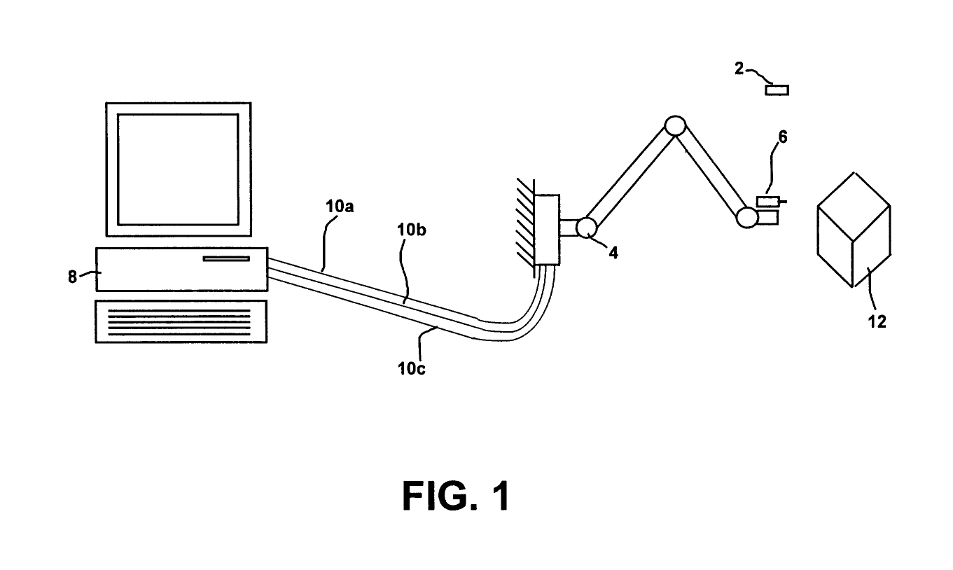

FIG. 1 is a schematic perspective illustration of the system of the first embodiment of the present invention; and,

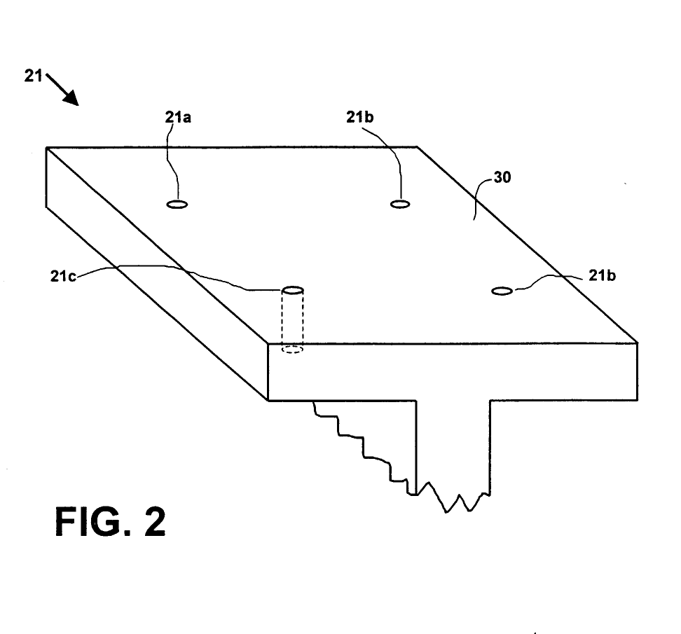

FIG. 2 is a schematic perspective view of a foot of a wing box rib prior to assembly with a wing skin;

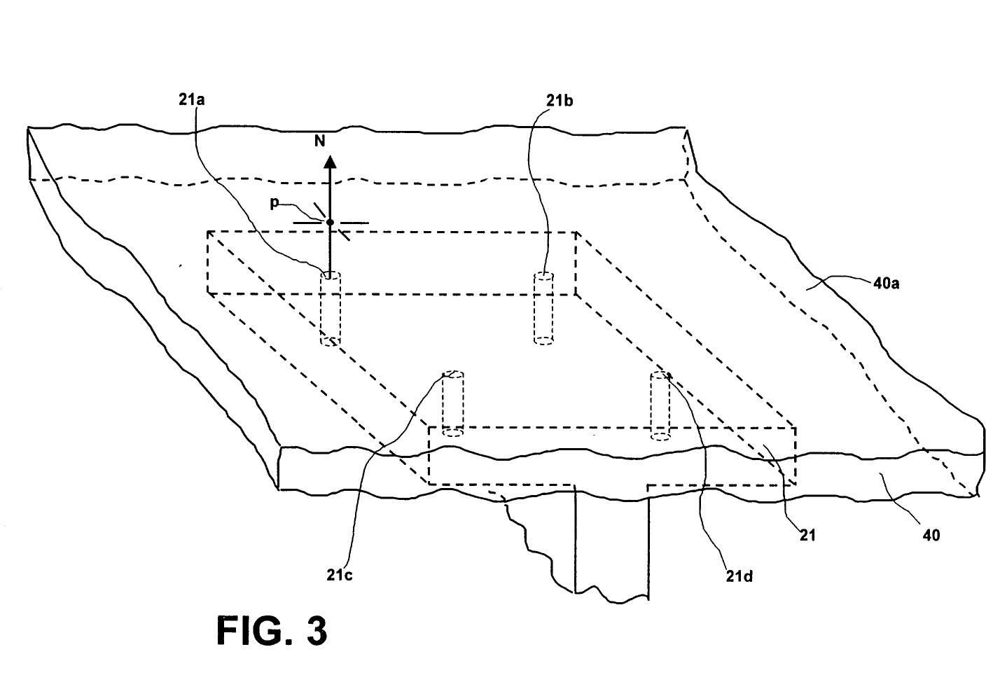

FIG. 3 shows a schematic perspective view of the foot of a wing box rib, shown in FIG. 2 with the wing skin in place, with a drill point on the wing skin being indicated.

### FIRST EMBODIMENT

System Hardware

Referring to FIG. 1, the marking out system of the present embodiment is illustrated. The system consists of a marking out device, which in the present embodiment is a bubble jet printer head 2, a contact measurement probe 6, a jointed arm portable co-ordinate measuring machine 4 and a general purpose portable personal computer 8. Any suitable bubble jet printer head may be used, such as those used for industrial packaging and marking applications. Similarly, any suitable contact measurement probe 6 may be used, such as those supplied with jointed arm portable co-ordinate measuring machines.

Both the bubble jet printer head 2 and the contact measurement probe 6 are arranged to be rigidly connected to the wrist 4a of the jointed arm portable co-ordinate measuring device 4. In the present embodiment, the wrist 4a of a jointed arm portable co-ordinate measuring device 4 supports either bubble jet printer head 2 or the contact measurement probe 6 at a given time, as shown in FIG. 1 where the contact measurement probe 6 is shown mounted on the wrist 4a of a jointed arm portable co-ordinate measuring device 4. However, the invention may alternatively be implemented with both bubble jet printer head 2 and the contact measurement probe 6 being simultaneously carried by the wrist 4a of a jointed arm portable co-ordinate measuring device 4.

A suitable jointed arm portable co-ordinate measuring device is the Faro arm, available from UFM Limited, 416-418 London Road, Isleworth, Middlesex TW7 5AE, United Kingdom. The measuring device 4 is an unpowered portable co-ordinate measuring arm incorporating accurate angular encoders, which can output position information relating the position and orientation of the wrist 4a of the measuring device relative to the measuring device base in six degrees of freedom.

The measuring device 4 is connected to the portable personal computer 8 running a Windows operating system (such as Windows 95, 98 or NT), via a suitable connector 10a, such as an RS232. The contact measurement probe 6 and bubble jet printer head 2 are also, similarly connected to the personal computer 8 via connectors 10b and 10c respectively.

The personal computer 8 has loaded on it software allowing the personal computer 8 to upload, manipulate and display the position information output by the measuring device 4, and outputs of the contact measurement probe 6, as well as other CAD data. An example of suitable software for interfacing with the measuring device 4 (in this case a Faro arm) and the contact measurement probe 6 is Faro Technologies' AnthroCAM Portable-Measure 3.0, also available from UFM Limited, 416-418 London Road, Isleworth, Middlesex TW7 5AE, United Kingdom.

The personal computer 8 also has loaded on it driver software allowing the bubble jet printer head 2 to be controlled via the personal computer 8. Such software is generally specific to particular printer hardware. However, it is generally supplied by the manufacturer of the bubble jet printer head 2 with the printer head.

A CAD model of the part or assembly which is to be marked out is stored on a permanent storage medium of the personal computer 8, such as a hard disc drive or CD ROM. The CAD model includes not only data defining the three dimensional shape of the part to be marked out but also data defining the marking out scheme which is to be applied to the part, together with the locations of each element of the marking scheme on the part. Such marking out schemes may include not only points defining manufacturing or assembly locations, such as drilling locations, but may also include symbols or text which may be used in subsequent manufacturing, assembly or inspection operations, for example: drill diameters; drill depths; tolerances; fastener specifications; and, material information.

Mode of Operation

The operator of the system of the present embodiment commences operation of the system by mounting the contact measurement probe 6 on the wrist 4a of measurement device 4. The measuring device 4 base and the part 12 which is to be marked out are placed sufficiently close together for the contact measurement probe 6 and for the printer head 2 respectively to contact and print on the surfaces of the part 12 when mounted on the measuring device 4. The operator of the system also ensures that both the base of the measuring device 4 and the part 12 are securely positioned to ensure that no relative movement between measuring device 4 and the part 12 occurs during the subsequent operation of the system.

The operator then establishes the position and orientation of the part with respect to the base of the measurement device 4. This is achieved in the following manner. With the personal computer 8 running the interface software, interfacing with the measuring device 4 and the contact measurement probe 6, in its CAD based measurement mode, the operator selects a CAD file stored in the memory of the personal computer 8, which corresponds to the part to be marked out. Thus, position information relating to the part measured with the contact measurement probe 6 and the measuring device 4 may be related to the selected CAD file.

As the measuring device 4 is unpowered, the operator manoeuvres it such that the contact measurement probe 6 contacts the part 12, causing the contact measurement probe 6 to output a contact signal. The instantaneous position and orientation of the measuring device 4 during the contact signal is recorded in the memory of the personal computer 8 under the control of the interface software.

By recording the instantaneous position and orientation of the measuring device 4 for a minimum of six non-linearly spaced, non-planar locations on the surface of the part 12, a non-degenerate solution for the position and orientation of the part with respect to the measuring device base may be obtained by fitting the measured points to the CAD data for the part stored in the memory of the personal computer 8 using a conventional best fit algorithm.

The skilled reader will appreciate that the present invention may alternatively be implemented by measuring the position of datum points on the surface of the part 12, the position of which are known in the co-ordinate system of the part. The position data of corresponding points on the CAD model of the part 12 may then be set to the measured position values (in the co-ordinate system of the measurement device 4); thus, determining the position and orientation of the part 12 relative to the measurement device 4. In this case, a minimum of three such measurements is required to uniquely define the position and orientation of the part 12 with respect to the measuring device 4.

Once the position and orientation of the part has been established with respect to the measuring device 4, the marking out procedure may be commenced.

The operator initially exchanges the contact measurement probe 6 for the bubble jet printer head 2.

The bubble jet printer head 2 is then mounted on the wrist 4a of the measuring device 4 in such a manner that the spatial relationship, or angular and linear offsets, between the nozzles of the printer head 2 and the contact element of the measurement probe 6 is accurately known. Therefore, the operator is able to enter the relative offsets into the Interface software running on the personal computer 8 to ensure that the position and orientation of the nozzles of the bubble jet printer head 2 are accurately known with respect to the part 12. Alternatively, the task of calibrating the offsets between the nozzles of the printer head 2 and the contact element of the measurement probe 6 may be measured by carrying out a calibration routine. In such a routine, the operator may cause the print head to print one or more features on to a test surface and then manoeuvre the measurement probe into alignment with one or more of those features. The new position and orientation of the measuring device may then be measured and compared to that at which the test print step was carried out; thus yielding the required offsets.

The representation of the CAD model of part being marked out is shown on the screen of the personal computer 8, together with the marking out information which is to be applied to the part. In this embodiment, this information is illustrated in the representation of the CAD model as it will appear on the part itself when the marking out process in completed.

Also shown on the representation of the CAD model is an indication of the real time three dimensional position and orientation of the nozzles of the bubble jet printer head 2. This is determined by the Interface software using the output of the measuring device 4 and the offsets input by the operator. The skilled reader will appreciate that because the output of the measuring device 4 is used to determine the position and movement of the printer head 2, the normal feedback mechanisms used with such printer heads, for example odometers associated with the printer head 2, are not required in this embodiment of the present invention.

The operator then manipulates the printer head 2 into an approximate position and orientation with respect to the part 12 for printing marking out information on the part 12. This is done using the graphics of the CAD model, including the marking out scheme, and the printer head 2 displayed on the screen of the personal computer 8.

This process may be assisted through the use of a “rubber banding” feature in the software display, where the graphical representation of the printer head 2 displayed on the screen of the personal computer 8 is shown as being “linked” to the desired location on the graphical representation of the part 12 by a line, or “rubber band”; thus aiding the operator to correctly position the actual printer head 2 relative to the actual part 12 by minimizing the length of the “rubber band” displayed.

This process may be further assisted through the use of an automatic zooming feature, which shows the relevant portion of the CAD model on the screen of the personal computer in increasing levels of magnification as the printer head 2 approaches the desired location of a marking out location on the part 12.

The Interface software determines the exact position and motion of the print head 2 relative to the part 12; thus determining when to activate the printer head 2 to ensure that the printer head 2 prints the required marking out details in the correct location on the part 12 as the printer head passes over that location on the surface of the part 12. The software also uses data relating to the direction and speed of motion of the printer head 2 to determine any compensation of the print pattern which may be required to ensure accurate positioning of the marking out scheme.

The operator may continue to manipulate the measuring device 4 until all of the marking out information displayed on the screen of the personal computer 8 has been marked out on the part 12.

Finally, the manufacturing and assembly operations dependent upon the completed marking out scheme may be carried out in a conventional manner.

SECOND EMBODIMENT

The second embodiment of the present invention in general terms fulfils the same functions and employs the same apparatus as described with reference to the first embodiment. Therefore, similar apparatus and modes of operation will not be described further in detail.

However, whereas the system and method of the first embodiment is arranged to mark out a part using measurements which are taken directly from that part, the system and method of the second embodiment is arranged to mark out a part based primarily on measurements which are taken from a further part. For example, in the case of assembling an aircraft wing skin to a wing box, where it is essential to determine accurately from the wing skin side of the structure where to drill attachment holes through the wing skin and into the supporting feet of a rib of the wing box, position measurements of the rib feet may be taken, prior to offering up the wing skin for fixing relative to the wing box. Once the wing skin is in place, those measurements may be used to determine the correct marking out scheme for applying to the wing skin so that it may be correctly assembled with the wing box; as is explained below.

Referring to FIG. 2, a single rib foot 1 of a rib of an aircraft wing box is illustrated. As can be seen from the figure, four guide holes 21a, 21b, 21c and 21d have been pre-drilled in the rib foot 21 in the desired locations of the final assembly holes, used for securing the wing skin. The guide holes 21a-21d are either drilled using a conventional drilling block (not shown) which is used to ensure that the guide holes are drilled perpendicular to the surface 3 of the rib foot 21, or are pre-drilled at the detailed manufacturing stage.

As with the first embodiment, a CAD model of the part or assembly which is to be marked out (in this case the entire wing box assembly, of which the rib foot and its associated rib (not shown) is a part) is stored on a permanent storage medium associated with the personal computer 8. The CAD model also defines the location and orientation of the guide holes 21a-21d relative to the rib foot 21 and wing box assembly (not shown) in general.

In the present embodiment, before the wing skin is offered up for fixing to the wing box, the positions and orientations of the guide holes 21a21d, together with the other guide holes (not shown) on other rib feet (not shown) to which the wing skin is to be assembled, are established. This is achieved by the operator manoeuvring the measuring device 4 such that the contact measurement probe 6 contacts the wing box assembly, causing the contact measurement probe 6 to output a contact signal which is output to the Interface software running in its CAD based measurement mode. The position and orientation of the wing box assembly may then be determined using the Interface software with reference to a CAD model of the wing box, as discussed in the previous embodiment. Thus, the position and orientation of any given feature of the wing box, including the position and orientation of each of the guide holes may be determined from the CAD model.

In the event that the section of wing box (or other structure) under consideration is a rigid structure, this may be achieved by measuring the position of a minimum of three known datum points or six unknown, non-linearly spaced, non-planar locations on the surface of the wing box and fitting these points to the CAD model of the wing box (or other structure) as is discussed with respect to the first embodiment.

However, if the section of wing box (or other structure) under consideration is relatively compliant, or very large then the location and orientation of smaller sub-assemblies, or parts of the wing box (or other structure) may be determined in the same manner as described above, in order to improve the accuracy with which the position and orientation of those sub-assemblies, or parts is determined. Such sub-assemblies may include, for example, individual ribs, individual rib feet, or the individual guide holes on the rib feet. The skilled reader will thus realise that a CAD model of the structure or part to be marked out is not required in order to implement the invention.

Once the positions and orientations of the guide holes 21a-21d have been established with respect to the measuring device base, the wing skin is offered up to the wing box and clamped in position. This is shown in FIG. 3, which shows a schematic perspective view of the wing skin 40 in position for assembly with the rib foot 21.

The operator then takes three or more position measurements of the upper surface of the wing skin 40 in the area of the wing skin overlying the rib foot 21, using the contact measurement probe 6, in the same manner as previously described. Thus, the Interface software is able to define a plane on which the three or more measured positions lie, which represents the upper surface 40a of the wing skin 40. This may be achieved using standard geometric techniques, such as a least mean squares algorithm, in the event that more than three position measurements of the upper surface of the wing skin 40 are taken. The plane representing the upper surface 40a of the wing skin 40 is then stored by the processor of the personal computer 8 as CAD data.

For each guide hole 21a-21d, a vector is computed, using standard geometric techniques, which passes through the centre of the guide hole along its longitudinal axis, and is normal to the local surface of the rib foot supporting the wing skin. This vector, for hole 21a, is illustrated by arrow “N” in FIG. 3.

Where the vector “N” intersects the plane representing the outer surface 40a of the wing skin 40, a drilling point is defined and stored in the memory of the personal computer 8. This point is referenced “P” in FIG. 3. Point “P” will be used to form part of the marking out scheme, which includes all other similarly calculated drilling points, which is to be applied to the wing skin surface 40a. Again, standard geometric techniques are used to compute the intersection of the plane by the vector “N”.

Once the position and orientation of the wing skin 40 has been established with respect to the measuring device base in all areas of interest, and once all required drilling points have been calculated, the marking out procedure may be commenced. This may be carried out in the same manner as described with reference to the first embodiment and therefore will not be described further.

Finally, a drilling operation is undertaken to drill at an angle normal to the local wing skin surface, through the wing skin at each marked out drilling point. This may be achieved using conventional methods. For example, by manual drilling using a drilling block to ensure the correct orientation of the drilled hole.

When the wing skins have been assembled with the wing box, using the method of the present embodiment, to form a completed wing assembly, the completed wing assembly may be mounted on an aircraft fuselage, in the assembly of an aircraft in a conventional manner.

Although in the present embodiment, the rib foot of the aircraft wing box rib is described as being pre-drilled with guide holes, the skilled reader will appreciate that in practice this need not be the case. The operation of drilling through the wing skin could in practice be extended to drill through the rib foot beneath.

FURTHER EMBODIMENTS

It will be clear from the foregoing that the above described embodiments are merely examples of the how the invention may be put into effect. Many other alternatives will be apparent to the skilled reader which are in the scope of the present invention.

Although in the above described embodiment an unpowered jointed arm portable co-ordinate measuring device is used, the skilled person will appreciate that a powered robotic arm, such as a Kuka™ industrial robot, could instead be used, which may be fixedly mounted or movably located.

Furthermore, although the position and orientation of the arm in the above described embodiment is determined using angular encoders, the skilled reader will appreciate that the position and orientation of the arm could alternatively be determined using conventional photogrammetry techniques.

As a further alternative, three laser trackers, each tracking a separate retro-reflector rigidly connected to the contact measurement probe and/or marking out device could be used to provide position and orientation information relating to the contact measurement probe and marking out device. Similarly one six degree of freedom laser tracker may also be used to implement the invention.

In a further alternative, the contact measurement probe and/or marking out device need not be mounted on a jointed arm co-ordinate measurement machine such as a Faro arm, but instead may be used in conjunction with a photogrammetry system or laser tracker system; for example, the contact measurement probe and/or marking out device may be mounted on a conventional photogrammetry probing tool (such as is disclosed in WO-A-91/16598), which is supported and moved manually by a system operator. In such an arrangement, the position and orientation of the probing tool may be measured using photogrammetry or laser trackers as mentioned above.

Although the measuring device may be used to give six degrees of freedom of movement, the skilled reader will appreciate that the required number of degrees of freedom of movement possessed by the arm is dictated by the requirements of the marking out task being undertaken. However, it will be understood that the invention may be applied to a system in which the contact measurement probe and/or marking out device are free to move in fewer than six degrees of freedom.

In the event that a robot is used in an implementation of the present invention, the skilled reader will appreciate that the marking out process could be implemented automatically under the control of a processor, such as a personal computer, programmed to control the articulation or movement of the robot arm.

Although the above embodiments use a contact measurement probe to determine the position and orientation of the part to be marked out, it will be appreciated that other sensors or transducers such as a laser striper or an ultrasonic distance measuring devices may also be used to advantage in the present invention.

Although the above embodiments use a bubble jet printer head to mark out a part, it will be appreciated that devices such as a mechanical punch, scriber, pen or other printing or marking devices may alternatively be used to advantage in the present invention.

The skilled reader will understand that in carrying out the marking out process of the above embodiments, the printer head may be swept primarily over those areas of the part where marking out is required, or alternatively, it may be swept systematically over the entire surface of the part. This may be an effective approach in the event that dense marking out detail is required over a small area and/or if the manipulation of the printer head during the marking out process is automated.

The skilled reader will also appreciate that in the second embodiment, the system may be programmed to calculate thickness of the wing skin. This may be done by determining the distance between the plane (defined by the three or more position measurements of the upper surface of the wing skin) in the area overlying a rib foot and the outer surface of the underlying rib foot. This calculated dimension may then be compared to the known thickness of the wing skin. If the calculated dimension exceeds the known dimension, it may be concluded that “gapping” has occurred and that the wing skin is not properly fitted against the rib foot. Thus, the wing skin may be offered up again.

Similarly, the a check that the outer surface of the rib foot and the outer surface of the wing skin are co-planar may be made. If they are not, it may again be concluded that “gapping” has occurred and that the wing skin is not properly fitted against the rib foot.

1. A marking out system for use in computer aided manufacture, the system comprising a measurement system and a marking out device, the measurement system storing CAD data of a part to be marked out comprising at least one marking out location, the measurement system comprising sensor means and a processor means and being arranged to determine the position and orientation of the part with respect to the measurement system and to establish a co-ordinate frame of reference allowing the position and orientation of the part to be related to the stored CAD data, the measurement system being further arranged to determine the position and orientation of the marking out device relative to the part to enable the marking out device to be positioned in a predetermined position relative to the part such as to allow the part to be marked in a location corresponding to the at least one marking out location.

2. A system according to claim 1, wherein the measurement means comprises a co-ordinate measuring device or a robot or the like, arranged to carry the marking out device and/or the sensor means.

3. A system according to claim 1, wherein the measurement means comprises a photogrammetry system and the marking out device and/or the sensor means is mounted on a photogrammetry probe.

4. A system according to any preceding claim, wherein the measurement system is further arranged to determine the orientation of the sensor means with respect to the measurement system.

5. A system according to any preceding claim, wherein the sensor means is a contact probe.

6. A system according to any one of claims 1 to 4, wherein the sensor means is a non-contact distance measuring device.

7. A system according to claim 6, wherein the sensor means is a laser stripe scanner.

8. A system according to claim 6, wherein the sensor means is an ultrasonic distance measuring device.

9. A system according to any preceding claim, wherein the marking out device comprises a printer head.

10. A method of marking out a part in computer aided manufacturing, the method comprising the steps of:
determining with sensor means the position and orientation of the part with respect to the sensor means;
establishing a co-ordinate frame of reference allowing the position and orientation of the part to be related to stored CAD data;
determining the position and orientation of a marking out device relative to the part;
positioning the marking out device in a predetermined position relative to the part; and,
marking the part in a location corresponding to a marking out location stored as CAD data.
